(19) United States
(12) Patent Application Publication
(10) Pub. No.: US 2007/0067803 A1
(43) Pub. Date: Mar. 22, 2007

(54) Method and apparatus for performing selectable channel search

(75) Inventors: Mark Gilmore Mears, Zionsville, IN (US); Bret David Hawkins, Brownsburg, IN (US); Joseph Wayne Forter, Zoinsville, IN (US); James Duanne Tenbarge, Fishers, IN (US)

Correspondence Address: THOMSON LICENSING INC., PATENT OPERATIONS, PO BOX 5312, PRINCETON, NJ, 08543-5312, US

(73) Assignee: Thomson Licensing Inc., Princeton, NJ (US)

(21) Appl. No.: 10/578,828

(22) PCT Filed: Dec. 22, 2004
(86) PCT No.: PCT/US04/43410

§ 371 Date: May 9, 2006

Related U.S. Application Data
(60) Provisional application No. 60/531,647, filed on Dec. 22, 2003.

(51) Int. Cl. H04N 5/445; G06F 3/00; G06F 13/00

(52) U.S. Cl. 725/52; 725/53; 725/56

(57) ABSTRACT

A method for performing a selectable channel search with an apparatus such as a television signal receiver provides users with flexible search options so that they may select only those search options they desire, and thereby save considerable time when performing a channel search. According to an exemplary embodiment, a method for enabling a channel search using a television signal receiver includes steps of enabling display of an on-screen menu, and enabling a user to select a plurality of options for the channel search responsive to the on-screen menu. The plurality of options includes a first option to search at least one of a plurality of inputs to the television signal receiver and a second option to search at least one of a plurality of types of channels.

### CROSS REFERENCE TO RELATED APPLICATION

This application claims priority to and all benefits accruing from a provisional application filed in the United States Patent and Trademark Office on Dec. 22, 2003, and there assigned Ser. No. 60/531,647.

### BACKGROUND OF THE INVENTION

1. Field of the Invention

The present invention generally relates to techniques for performing a channel search using an apparatus such as a television signal receiver, and more particularly, to a method and apparatus for performing a selectable channel search that provides users with flexible search options so that they may select only those search options they desire. This can eliminate unwanted search variables and thereby save considerable time when performing a channel search.

2. Background Information

Apparatuses such as television signal receivers may perform a channel search to detect available broadcast channels. One technique for performing a channel search includes scanning all possible frequencies for all possible channels. This type of channel search, however, can be a time-consuming process because of all of the variables that must be examined. This can be particularly true with television signal receivers capable of receiving and decoding both analog modulation channels (e.g., NTSC, PAL, SECAM, etc.) and digital modulation channels (e.g., ATSC, QAM, VSB, etc.). For example, with a television signal receiver capable of receiving and decoding ATSC channels, hundreds of ATSC major and minor channels need to be searched for available channels. If the television signal receiver is also able to receive and decode 64-QAM and 256-QAM channels, the major and minor channels of those modulation formats also need to be searched. Moreover, if the television signal receiver is also able to receive and decode NTSC channels, then the television signal receiver also needs to search for those available channels.

The channel search becomes even more time-consuming if the television signal receiver has a plurality of inputs (e.g. one for cable, one for terrestrial, one of satellite, one for internet, etc.) and each of those inputs are also searched for available channels. Moreover, a channel search may be made longer if channels that have already been found in a previous channel search are searched for again, and/or if the television signal receiver also detects the type of signal (e.g., cable signal, terrestrial signal, etc.) received on each input.

Accordingly, there is a need for a method and apparatus for performing a channel search using an apparatus such as a television signal receiver that avoids the foregoing problems, and is thereby capable of reducing the search time by providing users with flexible search options so that they may select only those search options they desire. The present invention addresses these and/or other issues.

### SUMMARY OF THE INVENTION

In accordance with an aspect of the present invention, a method for enabling a channel search using a television signal receiver is disclosed. According to an exemplary embodiment, the method comprises steps of enabling display of an on-screen menu, enabling a user to select a plurality of options for the channel search responsive to the on-screen menu, and wherein the plurality of options includes a first option to search at least one of a plurality of inputs to the television signal receiver and a second option to search at least one of a plurality of types of channels.

In accordance with another aspect of the present invention, an apparatus for enabling a channel search is disclosed. According to an exemplary embodiment, the apparatus comprises memory means for storing data that enables display of an on-screen menu, and processing means for enabling a user to select a plurality of options for the channel search responsive to the on-screen menu. The plurality of options includes a first option to search at least one of a plurality of inputs to the apparatus and a second option to search at least one of a plurality of types of channels.

In accordance with yet another aspect of the present invention, a television signal receiver is disclosed. According to an exemplary embodiment, the television signal receiver comprises a memory operative to store data that enables display of an on-screen menu, and a processor operative to enable a user to select a plurality of options for a channel search responsive to the on-screen menu. The plurality of options includes a first option to search at least one of a plurality of inputs to the television signal receiver and a second option to search at least one of a plurality of types of channels.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is an exemplary environment suitable for implementing the present invention;

FIG. 2 is a diagram providing further details of the apparatus of FIG. 1 according to an exemplary embodiment of the present invention;

FIG. 3 is a flowchart illustrating steps according to an exemplary embodiment of the present invention; and

FIG. 4 is an on-screen menu according to an exemplary embodiment of the present invention.

The exemplifications set out herein illustrate preferred embodiments of the invention, and such exemplifications are not to be construed as limiting the scope of the invention in any manner.

### DESCRIPTION OF THE PREFERRED EMBODIMENTS

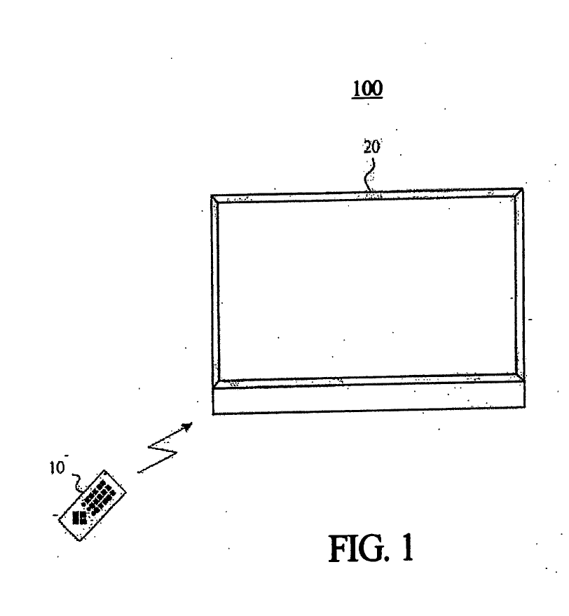

Referring now to the drawings, and more particularly to FIG. 1, an exemplary environment 100 suitable for implementing the present invention is shown. As indicated in FIG. 1, environment 100 comprises user input device 10, and an apparatus 20. According to an exemplary embodiment; apparatus 20 is embodied as a television signal receiver, but may be embodied as any apparatus or device that provides a channel search function, including an apparatus or device that does not include an integrated display device (e.g., set-top box, radio, etc.).

User input device 10 is operative to generate and output control signals that control the operation of apparatus 20 and/or other devices. According to an exemplary embodiment, user input device 10 includes a plurality of input keys and outputs control signals in a wired and/or wireless (e.g., via infrared or radio frequency (RF) link, etc.) manner responsive to user depression of its input keys. User input device 10 may for example be embodied as a hand-held remote control device, wired and/or wireless keyboard, integrated control panel of apparatus 20, and/or other user input device.

Apparatus 20 is operative to receive signals including audio, video and/or data signals in one or more analog modulation formats (e.g., NTSC, PAL, SECAM, etc.) and one or more digital modulation formats (e.g., ATSC, QAM, VSB, etc.) from one or more signal sources such as cable, terrestrial, satellite, internet and/or other signal sources and to provide aural and/or visual outputs corresponding to these received signals. Apparatus 20 is also operative to process received signals and provide the resulting processed signals to one or more other devices, and to receive signals from other devices.

Apparatus 20 is further operative to enable and perform a selectable channel search according to the present invention. According to an exemplary embodiment, the selectable channel search enables a user to select a plurality of options for a channel search responsive to an on-screen menu. The plurality of options includes a first option to search at least one of the inputs (e.g., cable input; antenna input, etc.) to apparatus 20 for available channels, and a second option to search at least one of a plurality of types of channels (e.g., digital modulation channels and analog modulation channels). Other options such as an option to detect the type of signals (e.g., cable signal, terrestrial signal etc., received on each of the inputs to apparatus 20, and an option to search channels found during previous channel searches may also be, provided. By providing these flexible search options, users may select only those search options they desire, thereby eliminating unwanted search variables and saving considerable time when performing a channel search. Further details regarding these aspects of apparatus 20 will be provided later herein.

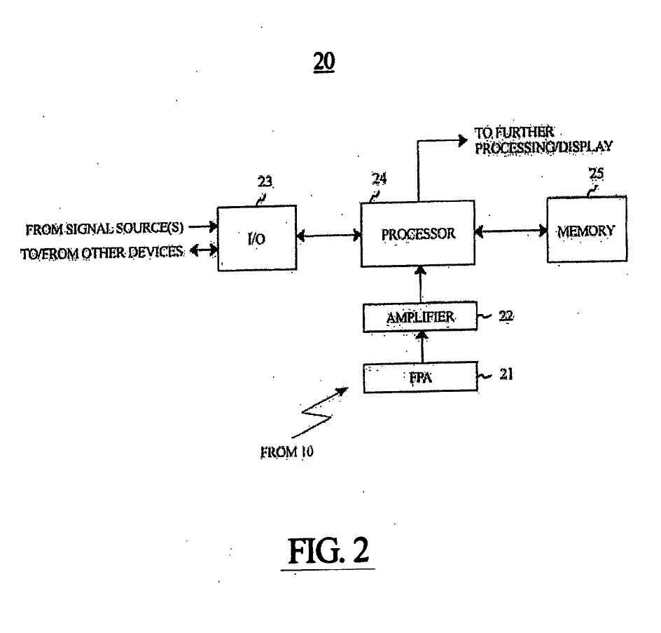

Referring to FIG. 2, a diagram providing further details of apparatus 20 of FIG. 1 according to an exemplary embodiment of the present invention is shown. Apparatus 20 of FIG. 2 comprises front panel means such as front panel assembly (FPA) 21, amplifying means such as amplifier 22, and input/output (I/O) means such as I/O block 23, processing means such as processor 24, and memory means such as memory 25. Some of the foregoing elements of FIG. 2 may be embodied using ICs, and some elements may for example be included on one or more ICs. For clarity of description, certain conventional elements associated with apparatus 20 such as certain control signals, power signals and/or other elements may not be shown in FIG. 2.

FPA 21 is operative to receive user inputs from user input device 10, and to output signals corresponding to the user inputs to amplifier 22. According to an exemplary embodiment, FPA 21 receives signals, such as IR and/or RF signals, from user input device 10 and generates corresponding signals which are output to amplifier 22. Amplifier 22 is operative to amplify the signals provided from FPA 21 for output to processor 24.

I/O block 23 is operative to perform I/O functions of apparatus 20. According to an exemplary embodiment, I/O block 23 is operative to receive signals such as audio, video and/or data signals in analog and digital modulation formats from one or more signal sources such as cable, terrestrial, satellite, internet and/or other signal sources. Although not expressly shown in FIG. 2, I/O block 23 may include a plurality of input terminals each designated to receive signals from a given signal source. For example, I/O block 23 may include separate input terminals for receiving signals from cable, antenna (i.e., terrestrial), satellite, internet and/or other signal sources. I/O block 23 is also operative to output processed signals to one or more other devices, and to receive signals from such devices.

Processor 24 is operative to perform various signal processing and control functions of apparatus 20. According to an exemplary embodiment, processor 24 processes the audio, video and/or data signals provided from I/O block 23 by performing functions including signal tuning, analog and digital demodulation, and other functions to thereby generate data representing audio, video and/or data content. The data produced from such processing functions may be provided for further processing (e.g., MPEG decoding, etc.) and output. Also according to an exemplary embodiment, processor 24 detects and processes user inputs provided via user input device 10, and may control its own operations and/or output control signals to control other elements of apparatus 20 (including elements not shown in FIG. 2) responsive to such user inputs.

Processor 24 is also operative to execute software code that enables a selectable channel search according to the present invention. According to an exemplary embodiment, processor 24 enables users to select various search options for performing such a selectable channel search. Processor 24 also enables performance of a channel search in accordance with the search options selected by a user. Processor 24 is also operative to perform and/or enable other functions of apparatus 20 including, but not limited to, enabling display of on-screen menus for user channel search option selection and other control of apparatus 20, detecting the types of signals received via I/O block 23, reading and writing data from and to memory 25, and/or other functions.

Memory 25 is operative to perform data storage functions of apparatus 20. According to an exemplary embodiment, memory 25 stores data including, but not limited to, software code, on-screen menu data, user selection data for a selectable channel search, and/or other data.

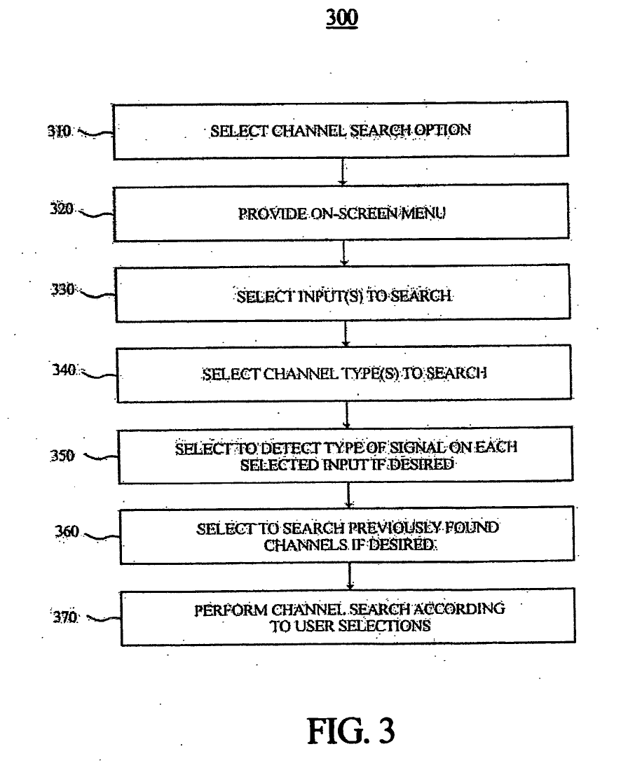

To facilitate a better understanding of the present invention, an example will now be provided. Referring to FIG. 3, a flowchart 300 illustrating steps according to an exemplary embodiment of the present invention is shown. For purposes of example and explanation, the steps of FIG. 3 will be described with reference to user input device 10 and apparatus 20 as previously described herein. The steps of FIG. 3 are merely exemplary, and are not intended to limit the present invention in any manner.

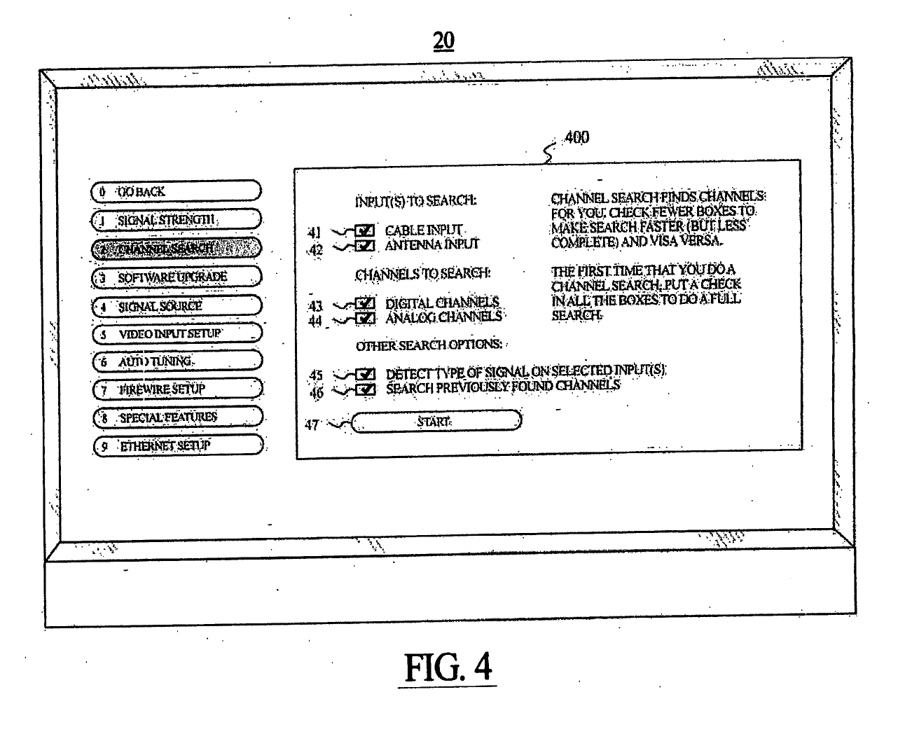

At step 310, a user selects a channel search option of apparatus 20. According to an exemplary embodiment, the user selects the channel search option at step 310 via user input device 10 responsive to an on-screen menu provided under the control of processor 24. An example of the on-screen menu provided at step 310 is represented by oval icons 0 to 9 in FIG. 4. As represented in FIG. 4, the user may manipulate user input device 10 to highlight and select oval icon 2 in FIG. 4 to thereby select the channel search option at step 310.

At step 320, apparatus 20 provides another on-screen menu to facilitate user selections for a selectable channel search according to the present invention. According to an exemplary embodiment, processor 24 enables display of the on-screen menu at step 320 responsive to the user's selection of the channel search option at step 310. On-screen menu 400 of FIG. 4 is an example of the on-screen menu provided at step 320. As shown in FIG. 4, on-screen menu 400 provides a plurality of user selectable options for performing a channel search represented as blocks 41 to 46, as will be described hereinafter.

At step 330, the user selects one or more inputs of apparatus 20 to be searched for available channels. According to an exemplary embodiment, the user may select at step 330 to search the cable input and/or the antenna (i.e., terrestrial) input of apparatus 20 for available channels. This option is represented as blocks 41 and 42 in on-screen menu 400 of FIG. 4. Accordingly, the user may manipulate user input device 10 to select block 41 and/or block 42 at step 330. In FIG. 4, the check marks in blocks 41 and 42 indicate that the user has selected to search both the cable input and the antenna input of apparatus 20. According to an exemplary embodiment, at least one of blocks 41 and 42 must be selected at step 330 or an error message (not shown) is displayed requesting that the user correct the condition by selecting one of blocks 41 and 42. However, if only one of these blocks 41 and 42 is selected at step 330, the resulting channel search will be performed more quickly than -if both blocks are selected. The user's selection at step 330 is stored in memory 25 under the control of processor 24 to enable a selectable channel search according to the present invention. Although on-screen menu 400 of FIG. 4 shows only two types of inputs (i.e., cable and antenna) to be searched, additional inputs (e.g., satellite, internet, etc.) of apparatus 20 may also be selectable for search according to the present invention.

At step 340, the user selects the types of channels for which to search. According to an exemplary embodiment, the user may select at step 340 to search for digital modulation channels (e.g., ATSC, QAM, VSB, etc.) and analog modulation channels (e.g., NTSC, PAL, SECAM, etc.). This option is represented as blocks 43 and 44 in on-screen menu 400 of FIG. 4. Accordingly, the user may manipulate user input device 10 to select block 43 and/or block 44 at step 340. In FIG. 4, the check marks in blocks 43 and 44 indicate that the user has selected to search for both digital modulation channels and analog modulation channels. According to an exemplary embodiment, at least one of blocks 43 and 44 must be selected at step 340 or an error message (not shown) is displayed requesting that the user correct the condition by selecting one of blocks 43 and 44. However, if only one of these blocks 43 and 44 is selected at step 340, the resulting channel search will be performed more quickly than if both blocks are selected. The users selection at step 340 is stored in memory 25 under the control of processor 24 to enable a selectable channel search according to the present invention.

At step 350, the user selects whether to detect the type of signal received on the input(s) selected at step 330 According to an exemplary embodiment, the user may select at step 350 whether to detect the type of signal (e.g., cable signal, terrestrial signal, etc.) received on the cable input and/or the antenna input of apparatus 20. This option is represented as block 45 in on-screen menu 400 of FIG. 4. Accordingly, the user may manipulate user input device 10 to select block 45 at step 350. In FIG. 4, the check mark in block 45 indicates that the user has selected at step 350 to detect the type of signal received on the input(s) of apparatus 20 selected at step 330. That is, if the user has previously selected at step 330 only the cable input (i.e., block 41) of apparatus 20 to be searched, then selecting block 45 at step 350 will cause processor 24 to detect the type of signal (e.g., cable signal, terrestrial signal, etc.) received on the cable input of apparatus 20 when the channel search is performed. Alternatively, if the user has previously selected at step 330 only the antenna input (i.e., block 42) of apparatus 20 to be searched, then selecting block 45 at step 350 will cause processor 24 to detect the type of signal (e.g., cable signal, terrestrial signal, etc.) received on the antenna input of apparatus 20 when the channel search is performed. Moreover, if the user has previously selected at step 330 both the cable input (i.e., block 41) and the antenna input (i.e., block 42) of apparatus 20 to be searched, then selecting block 45 at step 350 will cause processor 24 to detect the type of signals (e.g., cable signal, terrestrial signal, etc.) received on both the cable input and the antenna input of apparatus 20 when the channel search is performed. According to an exemplary embodiment, block 45 does not have to be selected at step 350, as this selection is entirely within the user's discretion. If block 45 is not selected at step 350, the resulting channel search will be performed more quickly, and vice-versa. The user's selection at step 350 is stored in memory 25 under the control of processor 24 to enable a selectable channel search according to the present invention.

At step 360, the user selects whether to search previously found channels. That is, the user may select at step 360 whether to search for channels that were found during previously channel searches. This option is represented as block 46 in on-screen menu 400 of FIG. 4. Accordingly, the user may manipulate user input device 10 to select block 46 at step 360. In FIG. 4, the check mark in block 46 indicates that the user has selected at step 360 to search for channels that were found during previously channel searches. According to an exemplary embodiment, block 46 does not have to be selected at step 360, as this selection is entirely within the user's discretion. If block 46 is not selected at step 360, the resulting channel search will be performed more quickly, and vice-versa. The user's selection at step 360 is stored in memory 25 under the control of processor 24 to enable a selectable channel search according to the present invention.

At step 370, apparatus 20 performs the channel search according to the user's selections at steps 330 to 360. According to an exemplary embodiment, processor 24 enables performance of the channel search at step 370 in accordance with the user's selections at steps 330 to 360 in response to the user activating a “Start” icon 47 shown in on-screen menu 400 of FIG. 4 via user input device 10. The results of the channel search may be displayed for the user to observe.

As described herein, the present invention provides a method and apparatus for performing a selectable channel search that provides users with flexible search options so that they may select only those search options they desire, and thereby save considerable time when performing a channel search. The present invention may be applicable to various apparatuses, either with or without an integrated display device. Accordingly, the phrase “television signal receiver” as used herein may refer to systems or apparatuses including, but not limited to, television sets, computers or monitors that include an integrated display device, and systems or apparatuses such as set-top boxes, video cassette recorders (VCRs), digital versatile disk (DVD) players, video game boxes, personal video recorders (PVRs), computers or other apparatuses that may not include an integrated display device.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method for enabling a channel search in a signal processing apparatus comprising the steps of:
generating a signal suitable for coupling to a display device for displaying an on-screen menu;
enabling a user to select a plurality of options for said channel search responsive to said on-screen menu; and
wherein said plurality of options includes a first option to search at least one of a plurality of inputs to said signal processing apparatus and a second option to search at least one of a plurality of types of channels.

2. The method of claim 1, wherein said plurality of inputs includes a cable input and an antenna input.

3. The method of claim 1, wherein said plurality of types of channels includes digital modulation channels and analog modulation channels.

4. The method of claim 1, wherein said plurality of options further includes a third option to detect a type of signal received via least one of said plurality of inputs.

5. The method of claim 4, wherein said plurality of options further includes a fourth option to search previously found channels.

6. The method of claim 5, further comprised of performing said channel search according to said plurality of options selected by said user.

7. An apparatus for enabling a channel search, comprising:
memory means for storing data used to generate a signal suitable for coupling to a display device for displaying an on-screen menu;
processing means for enabling a user to select a plurality of options for said channel search responsive to said on-screen menu; and
wherein said plurality of options includes a first option to search at least one of a plurality of inputs to said apparatus and a second option to search at least one of a plurality of types of channels.

8. The apparatus of claim 7, wherein said plurality of inputs includes a cable input and an antenna input.

9. The apparatus of claim 7, wherein said plurality of types of channels includes digital modulation channels and analog modulation channels.

10. The apparatus of claim 7, wherein said plurality of options further includes a third option to detect a type of signal received via least one of said plurality of inputs.

11. The apparatus of claim 10, wherein said plurality of options further includes a fourth option to search previously found channels.

12. The apparatus of claim 11, wherein said processing means enables performance of said channel search according to said plurality of options selected by said user.

13. A video signal processor, comprising:
a memory operative to store data used to generate a signal suitable for coupling to a display device for displaying an on-screen menu;
a controller operative to enable a user to select a plurality of options for a channel search responsive to said on-screen menu; and
wherein said plurality of options includes a first option to search at least one of a plurality of inputs to said video signal processor and a second option to search at least one of a plurality of types of channels.

14. The video signal processor of claim 13, wherein said plurality of inputs includes a cable input and an antenna input.

15. The video signal processor of claim 13, wherein said plurality of types of channels includes digital modulation channels and analog modulation channels.

16. The video signal processor of claim 13, wherein said plurality of options further includes a third option to detect a type of signal received via least one of said plurality of inputs.

17. The video signal processor of claim 16, wherein said plurality of options further includes a fourth option to search previously found channels.

18. The video signal processor of claim 17, wherein said controller is further operative to enable performance of said channel search according to said plurality of options selected by said user.
